(19) United States
(12) Patent Application Publication
(10) Pub. No.: US 2010/0330339 A1
(43) Pub. Date: Dec. 30, 2010

(54) DECORATIVE EFFECT FOR GLASS BODIES

(75) Inventors: Andrew G. Pomeroy, Ontario, NY (US); Paul D. Gray, Kendall, NY (US)

Correspondence Address: BROWN & MICHAELS, PC;400 M & T BANK BUILDING, 118 NORTH TIOGA ST, ITHACA, NY, 14850, US

(73) Assignee: APPLIED COATINGS GROUP, INC., Rochester, NY (US)

(21) Appl. No.: 12/851,057

(22) Filed: Aug. 5, 2010

Related U.S. Application Data
(63) Continuation-in-part of application No. 12/132,076, filed on Jun. 3, 2008.
(60) Provisional application No. 60/942,816, filed on Jun. 8, 2007.

(51) Int. Cl. B32B 3/02; B05D 5/06

(52) U.S. Cl. 428/156; 427/162

(57) ABSTRACT

Glass bodies are decoratively affected by having coatings of dichroic materials applied to an uneven surface, which in turn are coated with an opaque coating that may be protective, absorptive, or reflective. This combination of coatings transmits or reflects different colors of light in patterns that are determined by the unevenness of the coated surface, the design of the dichroic film, the design of the opaque coating, and an angle of view of an observer. Both the color patterns and the colors forming the patterns change with different viewing angles of the coated surface.

### REFERENCE TO RELATED APPLICATIONS

This is a continuation-in-part patent application of co-pending application Ser. No. 12/132,076, filed Jun. 3, 2008, entitled “DECORATIVE EFFECT FOR GLASS BODIES, which claims benefit of Provisional Application No. 60/942,816, filed Jun. 8, 2007, entitled “DECORATIVE GLASS BLOCK AND METHODS OF MANUFACTURING SAME”. The benefit under 35 USC §119(e) of the United States provisional application is hereby claimed, and the aforementioned applications are hereby incorporated herein by reference.

### BACKGROUND OF THE INVENTION

1. Field of the Invention

The invention pertains to the field of decorative glass. More particularly, the invention pertains to decorative glass blocks, glass tiles, and glass panels with dichroic coatings.

2. Description of Related Art

Glass has been used decoratively for millennia, and for decorative purposes, glass bodies have been shaped, surface patterned, colored, and surface coated in a multitude of ways. This nevertheless leaves unfulfilled an insatiable need for interesting new decorative effects.

### SUMMARY OF THE INVENTION

The decorative effect involves varying color patterns resulting from dichroic materials coated on an uneven surface of a glass body. The dichroic materials transmit or reflect different colors of light, and the unevenness of the coated surface imposes patterns on the colors of light that are transmitted or reflected. These colors and patterns of colors also change with different viewing angles of an observer, which adds considerably to their decorative interest.

Dichroic coatings, which are known, have been applied to smooth surfaces for optical and technical reasons. Applying dichroic coatings to uneven glass surfaces has the effect of making color vary unpredictably with viewing angles as compared with dichroics on smooth surfaces. Colors within the patterns can change, and forms of color patterns can also change with different viewing angles so that the decorative effect is made lively and surprising.

### BRIEF DESCRIPTION OF THE DRAWINGS

FIG. 1 is a cross-sectional view of a structural glass block having dichroic coatings on undulating internal surfaces.

FIG. 2 is an abstract representation of variable color patterns caused by the coating on the undulating surface of the block of FIG. 1.

FIG. 3 is a plan view of a glass tile having an uneven surface.

FIG. 4 is a cross-sectional view of the tile of FIG. 3 with a dichroic coating on an uneven surface and a protective coating over the dichroic coating.

FIG. 5 is a partially schematic representation of a frame that includes glass tiles or blocks for a door or wall panel providing variable color patterns according to the invention.

FIG. 6 is a photograph showing a stack of glass blocks that are made decorative according to the invention.

FIG. 7 is a photograph of the stack of glass blocks of FIG. 6 at a different viewing angle.

FIG. 8 is a cross-sectional view of the tile of FIG. 3 with a first dichroic coating on the uneven surface, an opaque coating over the first dichroic coating, and a second dichroic coating over the opaque coating.

FIG. 9 is a cross-sectional view of the tile of FIG. 3 with a first dichroic coating on the uneven surface, an opaque coating over the first dichroic coating, a second dichroic coating over the opaque coating, and a protective transparent coating over the second dichroic coating.

FIG. 10 is a front view of a structure with a frame and a glass block mounted in the frame.

FIG. 11 is a back view of the structure of FIG. 10.

FIG. 12 is a cross-sectional view of a tile with an uneven surface, a dichroic coating, and a partial coating.

### DETAILED DESCRIPTION OF THE INVENTION

The variable color patterns produced by the invention involve both an uneven surface of a glass body and a dichroic coating on the uneven surface. Uneven surfaces on glass bodies are known, and dichroic coatings on smooth plane surfaces are known, but neither of these by themselves produce color patterns of varying colors that change with an observer's angle of view. The term “uneven” as used herein refers to any combination of physical undulations or surface treatments such as acid etching or sand blasting to alter the surface topography. Dichroic coatings conforming to an uneven glass surface do produce such variable color patterns, which depend on the unevenness of a glass body surface, to result in non-uniform the layer thicknesses of dichroic coatings deposited on the glass body surface.

Dichroic materials and the formation of these materials into thin optical coatings are well understood. These are described for example in Thin Film Optical Filters, Third Edition by Angus Macleod. Dichroic materials have the property of transmitting or reflecting light of selected wave lengths or colors, and correspondingly not transmitting or not reflecting light of other wave lengths or colors. Many materials are known to have such dichroic properties, and many ways of coating these materials on a glass surface are also known. These include several forms of vacuum deposition and sputtering, for example.

Optical thin film coatings of dichroic materials are often used as filters, and these can be formed as long pass, short pass, band pass, interference, and mixtures of these. At least two dichroic material layers are required to achieve the decorative effects made possible by the invention, but many more than two layers can also be used. Four or more different dichroic layers are preferred to ensure that observable color patterns are interesting and variable. The dichroic materials used for coated layers also differ from each other in their index of light refraction.

Uneven surfaces of glass bodies contribute to the interesting color patterns achievable with the invention. The glass body surfaces can be uneven in a multitude of ways. One way is to have an uneven topography with hills and valleys, for example. The unevenness can be predetermined by a mold or die or can even be random resulting from manufacturing irregularities. The insides of structural glass blocks, for example, are readily molded with an undulating surface that works well with dichroic materials.

Uneven surfaces can also be patterned with variations that range from a micro to a macro scale. A pattern can repeat several times over a glass surface or a single pattern can extend its variation over a whole substrate, for example. Patterned unevenness of a glass surface can be textured to have visible irregularities. A glass surface can also be roughened by etching or sand blasting, and roughening can be applied in patterns that leave some of the surface specularly reflective.

An uneven surface can also affect the thickness of layers of dichroic materials and the degree of reflected light diffusion. The inherent variability of the coating process results, to a degree, in the non-uniformity of the layer thickness of the coating across the surface. The unevenness of the surface being coated can additionally attribute varying thickness to the layers of coated materials. These variations can add unpredictable interest to the observable color patterns. An uneven surface can also be formed by etching, sand blasting, or other technique that modifies the reflectance and transmission of a glass surface that is otherwise nearly plane. Both front and back surfaces of a glass body can be made uneven, and the unevenness can be different for opposite surfaces so that each surface can contribute to the interesting effects achieved.

Combinations of uneven glass surfaces and dichroic coatings can be complex enough so that the ways that color patterns will form and vary with different viewing angles can be quite unpredictable. This can add considerably to the decorative interest of a product, and interesting variation in the end result can even be left to random variations in manufacturing processes.

The color of the glass used for a glass body can also play a role in the decorative effect produced. Dichroic coatings can be designed with glass color in mind to take advantage of different color pattern effects derivable from the dichroic coatings, the unevenness of surfaces, and the color of the glass substrate.

Structural glass blocks generally include internal surfaces, and dichroic coatings are preferably designed for internal surfaces of glass blocks. One or both of these surfaces can be coated with dichroic materials, but generally coating one surface is sufficient. The coating within the interior of a glass block is preferred as naturally protected by the structure of the block itself

Glass tiles, which are often laid on a wall, a floor, or other building surfaces, such as a counter top, door, or table, produce visible colored patterns by reflectance from the dichroic coating that is preferably on a back surface of the tile. The dichroic coatings on the back side of a tile are also preferably covered with a protective coating, which is preferably opaque, so that the surface on which the tiles are mounted is not visible. In some embodiments, the opaque coating is reflective. In other embodiments, the opaque coating is absorptive only and non-reflective. In all cases, the opaque coating has a significant influence on the color that the tile, panel, or glass block exhibits.

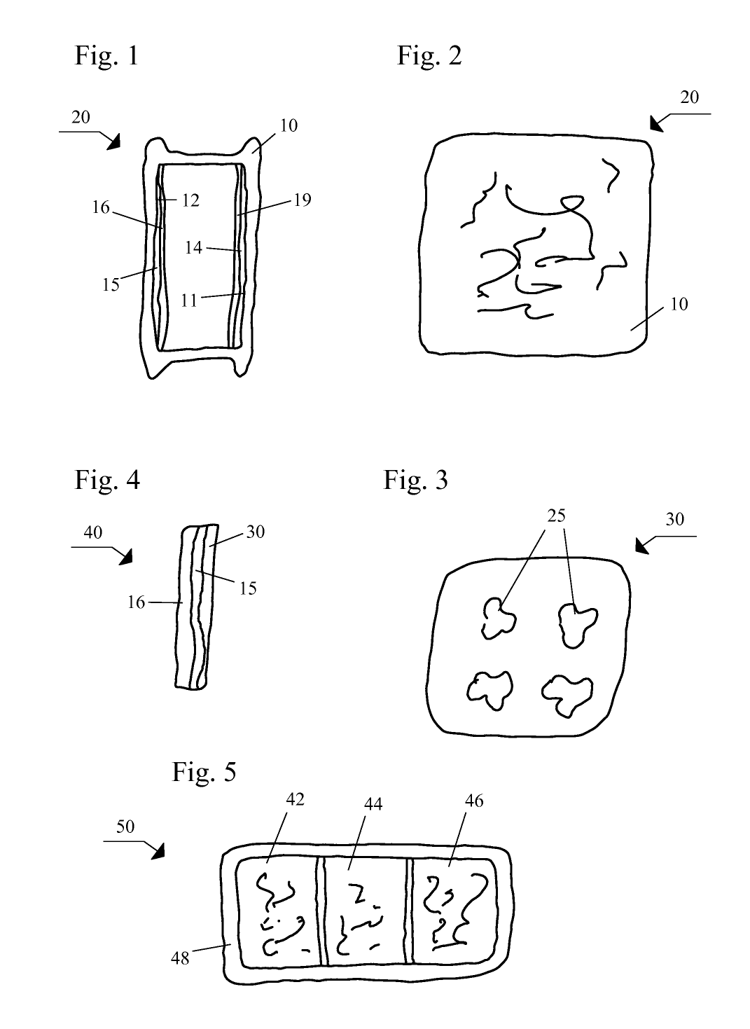

The cross-sectional view of the glass block 10 of FIG. 1 shows a multi-layered dichroic coating 14 deposited or coated on an internal surface 11 of the block 10. A second interior surface 12 can be coated with dichroic layers 15 as well, when the desired effect is to have a decorative result on both surfaces of the glass block, such as in a free-standing wall. Light transmitted through the glass and color reflected from the dichroic coatings 14, 15 in combination with the protection/reflection/absorption layers 19, 16, respectively, is affected by the unevenness of the surfaces 11, 12, the materials used in dichroic layers 14, 15, and the protection/reflection absorption layers 19, 16 for an observer. External surfaces of the glass block 10 can also be coated with dichroic materials, but this subjects the coatings to damage.

The abstract representation of a variable color pattern for the coated block 20 as viewed in FIG. 2 is endlessly variable by changing an angle of view. The coated block 20 appears different when viewed from different angles and can appear different or the same when viewed from different sides. These changes vary not only the colors that are made visible, but the patterns of those colors. It is therefore possible to make coated blocks that are endlessly variable among themselves by having different dichroic coatings, different protective/reflective/absorption coatings, and different surface unevennesses.

Applying an opaque coating to a dichroic layer on the back surface of a glass tile or block allows the tile or block to be applied on an opaque structure, such as a wall, floor, countertop, or piece of furniture, without the dichroic effect being altered or diminished by the opaque structural material behind the mounted glass tile or block. In some embodiments, the opaque layer is non-reflective. In some embodiments, the opaque layer is a black, absorptive, non-reflective layer. In other embodiments, the opaque layer is a colored layer that is reflective or semi-reflective. In other embodiments, the opaque layer is selected to absorb or reflect only certain specific wavelengths in the visible light spectrum. In some embodiments, an opaque layer with both absorptive and reflective properties is selected in combination with the materials for the dichroic layers to achieve a desired artistic or aesthetic effect of the overall total reflection of the coated glass. The opaque layer may be selected in combination with the dichroic layers based on the color of the opaque layer and the reflected and transmitted colors of the dichroic layers to produce a unique color or combination of colors in the final product. For example, a red opaque layer is chosen to reflect only red light but the dichroic layers are selected to reflect blue light and transmit red, with the resulting color being a combination of red and blue reflected light.

The glass tile 30 of FIG. 3 has features 25 making a rear surface of the tile 30 uneven. These features 25 may be random hill or ridges as part of a random topography or a textured pattern. This uneven surface is coated with dichroic layers 15, which in turn are covered with a protective/reflective/absorptive opaque layer 16, as shown in FIG. 4. The dichroic materials 15 interact with the uneven features 25 to change colors in different ways at different viewing angles. The features 25 can repeat as a regular pattern illustrated in FIG. 3, or can extend in a single variation across the whole surface of the tile 30. The patterns that can be used, the dichroic materials and materials that can be applied, and the protective/reflective/absorptive coatings that can be applied are practically endless. An added variation can be use of different colors of glass for the substrate of the tile 30.

Glass tiles can have opaque rear coatings 16, as shown in FIG. 4, and then be arranged back-to-back to present one variable color pattern on one side of a panel and another variable color pattern on the other side of the panel.

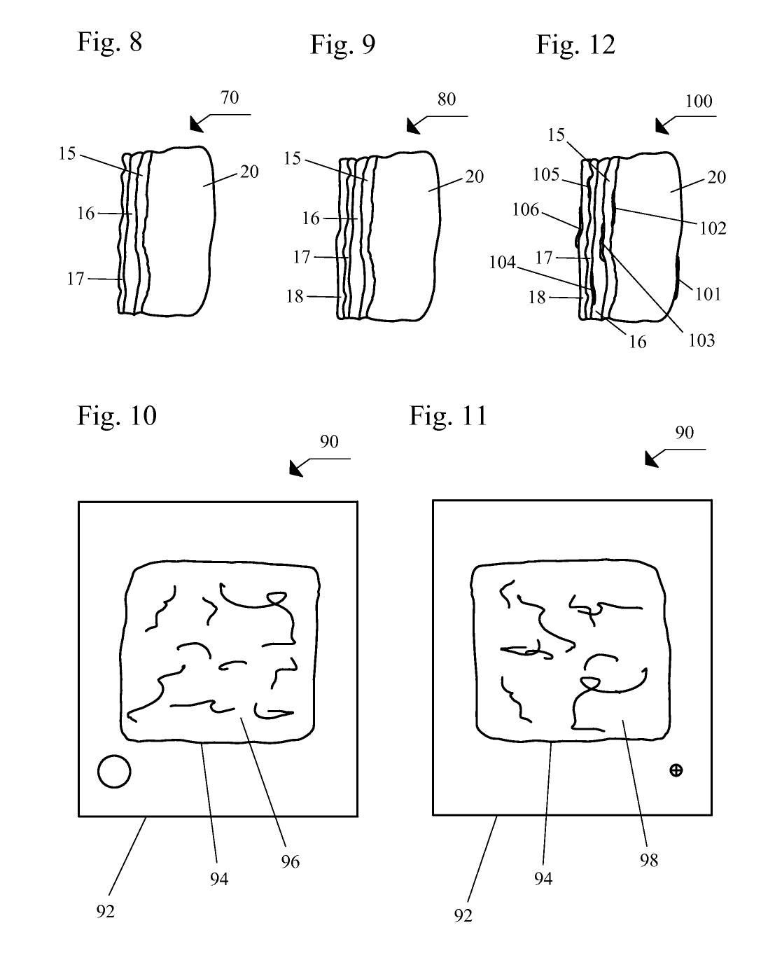

The panel 50 of FIG. 5 schematically shows three tiles or blocks 42, 44, 46 arranged within a frame 48 for use in a door or on a wall. The blocks or tiles 42, 44, 46 can be reflective and displayed against an opaque backdrop. Glass tiles can also be arranged back-to-back in the panel 50 so that the tiles produce color patterns reflectively on both sides of the panel 50 or a multiple layer design, such as in FIG. 8, FIG. 9, or FIG. 12, can achieve the same result without having to place the tiles back-to-back. Such patterns can vary on different sides of a panel, and at least one opaque coating can prevent transmission of light through the structure.

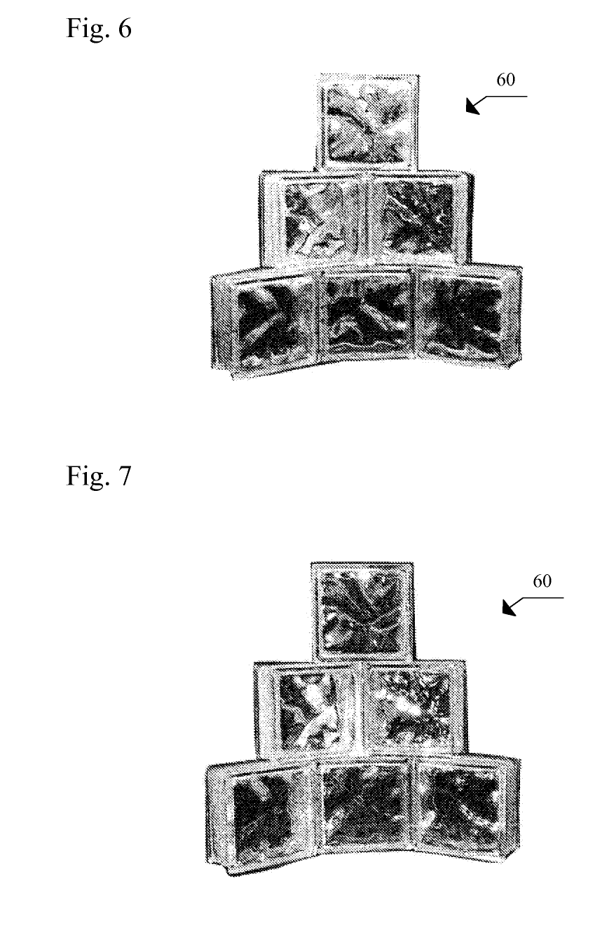

A stack of glass blocks 60 similar to the block 10 of FIGS. 1 and 2 are viewed at different camera angles in FIGS. 6 and 7. These different views show how color patterns from the same blocks change with a small change in a viewing angle.

As an alternative to arranging glass tiles back-to-back to produce non-transmissive color patterns on opposing sides of a structure, the coated glass tile or block 70 in FIG. 8 includes dichroic layers 15, which in turn are covered with an absorptive or reflective opaque layer 16. The opaque layer is then coated with additional dichroic layers 17. In some embodiments, the additional dichroic layers 17 are coated with a transmissive protective layer 18 as shown in the coated glass tile or block 80 of FIG. 9. In some embodiments, the transmissive protective layer 18 is a silicon dioxide film. The thickness of the transmissive protective layer 18 is preferably selected based on the amount of protection desired for the exposed rear surface of the coated glass tile 80 depending on the intended use of the coated glass tile 80. The coated glass tiles 70, 80 of FIGS. 8 and 9 are thinner and less expensive than two coated glass tiles 40 of FIG. 4 placed back-to-back.

A coated glass tile 94 such as in FIG. 8 or FIG. 9 is mounted in a support structure 92 to form a structure 90 with the first dichroic coating 96 visible on the first side of the structure 90 and the second dichroic coating 98 visible on the second side of the structure 90 such as in FIGS. 10 and 11. In some embodiments, the support structure 92 is a solid frame such as a wood, metal, or plastic frame. In other embodiments, the support structure 92 is an adhesive or binder such as cement, concrete, or thinset to connect multiple glass tiles in a single structure. The structure 90 is preferably any structure, which is viewable on both sides and has a thickness dimension significantly less than width and height dimensions, including, but not limited to, doors, especially kitchen cabinet doors and bathroom shower doors, and interior walls.

A non-dichroic partial coating layer may be printed on the surface of the glass or on any of the above-described coating layers within the spirit of the present invention for an additional decorative effect. The partial coating layer may be translucent, opaque and reflective, or opaque and non-reflective. The partial coating covers only a portion of its substrate and may have any form including, but not limited to, random shapes, repetitive patterns, artistic designs, photographic images, letters, numerals, and any combination of these. FIG. 11 shows a coated glass tile 100 with a patterned coating layer 101 on the tile 20 on a side opposite the uneven side, a patterned coating layer 102 on the tile 20 on the uneven side under a dichroic layer 15, a patterned coating layer 103 between the dichroic layer 15 and the opaque layer 16, a patterned coating layer 104 between the opaque layer 16 and the additional dichroic layer 17, a patterned coating layer 105 between the additional dichroic layer 17 and the transmissive protective layer 18, and a patterned coating layer 106 on the transmissive protective layer 18.

A glass tile or panel may be of any dimensions within the spirit of the present invention. The glass tiles or panels are typically soda lime glass, but other types of glass, such as quartz glass and borosilicate glass, or treatments to glass such as tempering, may also be used within the spirit of the present invention. Dichroic depositions are preferably done by a physical vacuum deposition process at temperatures of about 500 degrees F.

Alternatively, the dichroic layers may be deposited by chemical vapor deposition or sputtering.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A decorative effect applied to a glass surface of a glass tile, glass panel, or glass block, the glass surface being a rear surface of the glass tile, glass panel, or glass block, the decorative effect comprising:
the glass surface being uneven by having a non-planar topography;
a first set of dichroic layers comprising at least two dichroic materials having dichroic effects and applied to the glass surface, the first dichroic layers having an uneven thickness over the glass surface;
an opaque coating covering the first dichroic layers, the opaque coating blocking light transmission so that light only reflects from the decorative effect; and
the first dichroic layers effecting a color pattern of the light reflected from the first dichroic layers in combination with the impact of light reflection from the opaque coating resulting in the reflected light varying with different angles of view of the glass tile, glass panel, or glass block.

2. The decorative effect of claim 1, wherein the glass surface is part of a wall or door panel.

3. The decorative effect of claim 1, wherein the non-planar topography is an undulated topography.

4. The decorative effect of claim 1, wherein the non-planar topography is a textured pattern.

5. The decorative effect of claim 1, further comprising a second set of dichroic layers comprising at least two dichroic materials having dichroic effects applied to the opaque coating, the second dichroic layers effecting a color pattern of the light reflected from the second dichroic layers in combination with the impact of light reflection from the opaque coating resulting in the reflected light varying with different angles of view of the glass tile, glass panel, or glass block.

6. The decorative effect of claim 5, further comprising a transmissive coating covering the second dichroic layers.

7. The decorative effect of claim 1, further comprising a non-dichroic partial coating layer located on a printing surface selected from the group consisting of the rear surface of the glass tile, glass panel, or glass block and the surface of the first dichroic layers, wherein the non-dichroic partial coating layer coats only a portion of the printing surface.

8. The decorative effect of claim 7, wherein the non-dichroic partial coating layer is a layer selected from the group consisting of a transmissive layer, a non-reflective opaque layer, and a reflective opaque layer.

9. The decorative effect of claim 7, wherein the non-dichroic partial coating layer comprises a form selected from the group consisting of at least one random shape, at least one repetitive pattern, at least one artistic design, at least one photographic image, at least one letters, at least one numeral, and any combination of these.

10. A method of imposing a color pattern on light reflected from a glass tile, glass panel, or glass block, the method comprising:
a) coating at least two dichroic materials on an uneven rear surface of the glass tile, glass panel, or glass block to form a first set of dichroic layers;
b) forming the first dichroic layers with an uneven thickness over the glass surface;
c) applying an opaque coating over the dichroic materials on the uneven rear surface to allow light to reflect only; and
d) using the unevenness of the layer thickness of the dichroic materials in combination with the impact of light reflection from the opaque coating to impose a color pattern on the reflected light, the color pattern being variable with changes in an angle by which an observer views the glass tile, glass panel, or glass block.

11. The method of claim 10, wherein the uneven rear surface has an undulated topography.

12. The method of claim 10, wherein the uneven rear surface has a textured pattern.

13. The method of claim 10, wherein the coated glass surface forms part of a wall or door panel.

14. A decorative glass tile, glass panel, or glass block comprising:
a glass tile, glass panel, or glass block having a front surface facing toward an observer and a rear surface opposite the front surface, the rear surface being uneven by having a non-planar topography;
a first set of dichroic layers comprising at least two dichroic materials having dichroic effects and applied to the glass surface, the first dichroic layers having an uneven thickness over the glass surface;
an opaque coating covering the first dichroic layers, the opaque coating blocking light transmission so that light only reflects;
a color pattern being imposed by light reflecting from the dichroic materials in combination with the impact of light reflection from the opaque coating; and
the color pattern varying with different angles of view of an observer looking at the front surface.

15. The decorative glass tile, glass panel, or glass block of claim 14, wherein the non-planar topography is a textured pattern.

16. The decorative glass tile, glass panel, or glass block of claim 14, further comprising a second set of dichroic layers comprising at least two dichroic materials having dichroic effects applied to the opaque coating, the second dichroic layers effecting a color pattern of the light reflected from the second dichroic layers in combination with the impact of light reflection from the opaque coating resulting in the reflected light varying with different angles of view of the glass tile, glass panel, or glass block.

17. The decorative glass tile, glass panel, or glass block of claim 16, further comprising a transmissive coating covering the second dichroic layers.

18. The decorative glass tile, glass panel, or glass block of claim 14, further comprising a non-dichroic partial coating layer located on a printing surface selected from the group consisting of the rear surface of the glass tile, glass panel, or glass block and the surface of the first dichroic layers, wherein the non-dichroic partial coating layer coats only a portion of the printing surface.

19. The decorative glass tile, glass panel, or glass block of claim 18, wherein the non-dichroic partial coating layer is a layer selected from the group consisting of a transmissive layer, a non-reflective opaque layer, and a reflective opaque layer.

20. The decorative glass tile, glass panel, or glass block of claim 18, wherein the non-dichroic partial coating layer comprises a form selected from the group consisting of at least one random shape, at least one repetitive pattern, at least one artistic design, at least one photographic image, at least one letters, at least one numeral, and any combination of these.
